(19) United States
(12) Patent Application Publication
(10) Pub. No.: US 2013/0022456 A1
(43) Pub. Date: Jan. 24, 2013

(54) Axial flow action turbine

(71) Applicant: Kalman N. Lehoczky, Manatee County, FL (US)

(72) Inventor: Kalman N. Lehoczky, Manatee County, FL (US)

(21) Appl. No.: 13/136,020

(22) Filed: Jul. 20, 2011

(51) Int. Cl. F03B 3/18; F03B 3/04; F03B 11/02

(52) U.S. Cl. 415/208.2; 415/221; 415/208.1

(57) ABSTRACT

Axial flow action turbine utilizing the energy of water entering axially and tangentially into a turbine runner with cylindrical hub equipped with radial oriented buckets having cross-section consisting of segments of cylindrical tube where the segments are angularly offset along the bucket's radial axis and where the water exits the turbine runner axially.

### BACKGROUND OF THE INVENTION

1. Field of Invention

This invention relates to turbines converting the hydraulic energy in low head water current into mechanical rotational energy that to be used to drive the shaft of electrical generators, pneumatic compressor or other energy converters. The typical application area is rivers with small elevation drop.

2. Description of the Prior Art

The conventional energy conversion system for low-head hydroelectric power plant consists of a solid concrete or earth-fill dam, penstock leading the water from a higher elevation retained behind the dam to adjustable wicket gate or jets that guides and regulates the water flow into a turbine runner with fixed or adjustable blades and a draft tube leading the water out in a reservoir on low elevation. The turbine runner converts the hydraulic power into mechanical power and delivers it through a shaft to the electric generator which is usually installed above the turbine. Another type of low-head hydroelectric plant utilizes so called “bulb-turbine” that has horizontal shaft carrying both the generator rotor and the turbine runner. The generator as a whole is contained in a closed so called bulb housing that is surrounded by the axial flowing water that passing through the wicket gate turns the turbine runner. All existing designs are made for relative large, many megawatt units and targeting high efficiency and perfection of details. For example the blades in the turbine runners and wicket gates are thick and with a complex geometry demanding an expensive manufacturing process. Imitating the above design for smaller units would make the price of the turbine—generating unit and the generated power unrealistic high.

### SUMMARY OF INVENTION

Briefly stated, in accordance with one aspect of the present invention axial flow action turbine utilizing the energy of moving water entering axially and tangentially into a turbine runner with cylindrical hub equipped with radial oriented buckets having cross-section consisting of segments of cylindrical tube where the segments are angularly offset along the bucket's radial axis and where the water exits the turbine runner axially.

Other features of the invention will be described in connection with the drawings.

### DESCRIPTION OF THE DRAWINGS

FIG. 1 shows the radial-axial section (a) and the axi-parallel view (b) of a runner in accordance with the present invention.

The hub 1 carries the blades 2 with cross-section S1 and S2. The turbine runners rotational axis is 6. As an option in accordance with the present invention the external ends of the buckets may be interconnected by an external ring 3. The main purpose of the external ring 3 is the mechanical strengthening of the runner and prevent vibrations. The secondary purpose is the axial guidance of the water flow.

FIG. 2 shows the bucket's 1 cross-section close to the hub, S1, and close to the external end, S2. The rotational direction, R, is indicated. FIG. 2 shows that the cross-sections are segments of a cylindrical shell thus the blades can be made out of a cylindrical tube with internal radius ri and wall thickness t. The radial axis of the bucket is indicated with 5. Also the flow vectors in accordance with the classical turbine theory are shown. The present example is based on two assumptions. The first one is that entrance flow, C11, is identical both at the internal, S1, and external, S2, end of the blade. The second assumption is that the exit velocity, C12, is equal both at the internal, S1, and external, S2, end of the blade and that the exit flow has only axial component, C12=Cm12. During the passage through the turbine runner the water delivers practically all kinetic energy to the buckets 2 and the water leaving the runner has no rotational kinetic energy. This fact puts this turbine runner in the group of the so called “action” or “impulse” turbines. The number of buckets 2 carried by one hub 1 does not represent a limitation for this invention.

The difference between the flows at the internal and external section is that the bucket's circumferential velocities at section, S1, and S2 are different: U1<U2, dictated by the different radius at these locations. The consequence of this difference will be that more energy will be converted at S2 compared to S1. This difference is inevitable and acceptable. In order to achieve the assumed flow vector diagrams the blade must be cut from the tube with a different angles, a11<a21 and a12>a22 in the internal, S1, and external, S2, region.

The special geometry of the buckets and its manufacturing is explained in connection with FIG. 3. The figure shows the external side view and axial view of a tube 4 with wall diameter D and axial length L, while the relatively thin wall with thickness t, is only indicated. The bucket's axis 5 and tube axis are identical. On the external surface of the tube 4 the future leading H1-E1 and trailing edges H2-E2 of the bucket are indicated. For the sake of simplicity these edges are assumed to be straight lines. Lines H1-E1 and/or H2-E2 different from the straight line do not limit the validity of this invention. Looking at the axial view of the tube 4 the same end points of the edges, H1, E1, H2 and E2 are indicated. Connecting the leading edge points, H1-H2, end E1-E2, respectively, the angular positions, B1 and B2, of the bucket's cross-sections also called profiles in relation to an arbitrary chosen reference line, B, are defined. The H1-H2 line, eventually a curve should fit the cylindrical surface of the hub while E1-E2 line eventually curved should fit the internal cylindrical surface of the external ring 3. In accordance with this invention the chosen location of points H1, H2, E1 and E2 defines the bucket geometry with respect to the angular position of bucket profiles at different locations along the radial axis 5 of the bucket. Stated another way the pitch of the bucket will vary along the bucket's radial axis.

In accordance with this invention the bucket's 2 radial axis 5 may tilt in relation to the theoretical radial direction thus it can tilt forward or backward in relation to rotation R and/or have an angle that is not perpendicular to the turbine runner's rotational axis 6.

In accordance with this invention the bucket's 2 cross-section may be composed of more than one cylindrical tube segments as shown in FIG. 4. This example consists of three cylindrical segments, 7, 8 and 9. The tube segment 7 and 8 has internal radius R1 and R2 respectively. The third component is a tube with radius R3 that may act as the leading edge of the bucket profile. The components may be assembled by welding 10 at the indicated locations. Obviously the welding surface may be smoothened in order to optimize the boundary layer of the water flow.

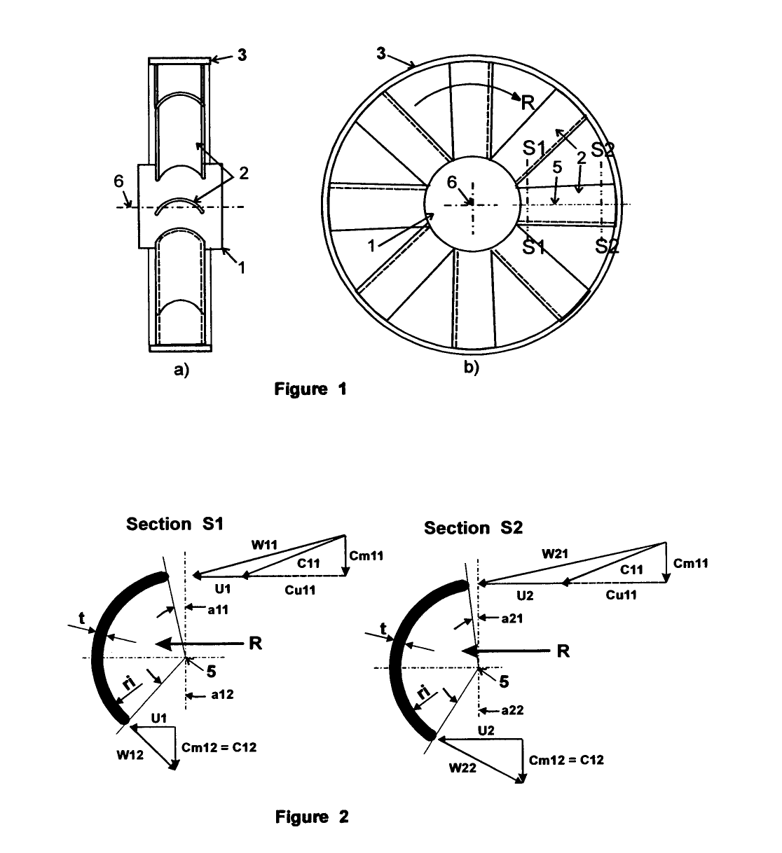

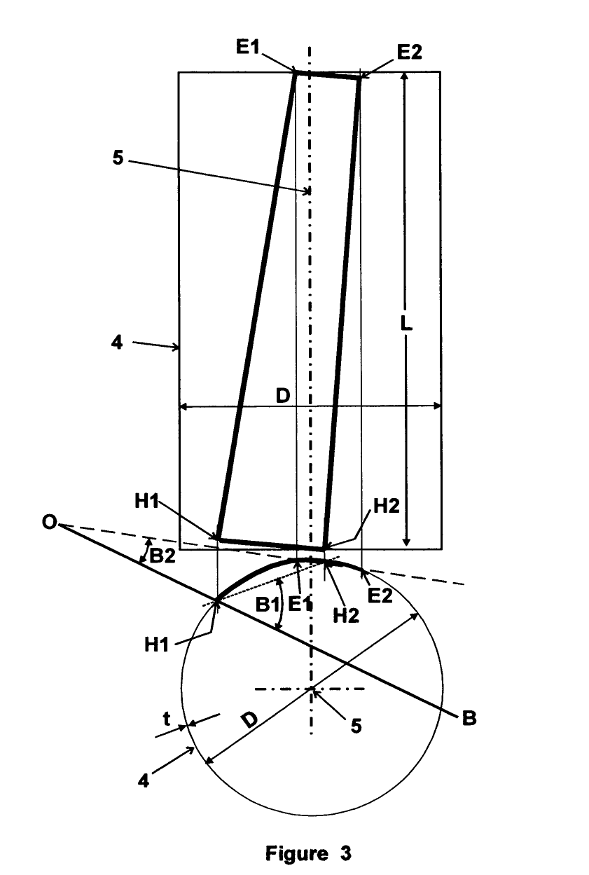

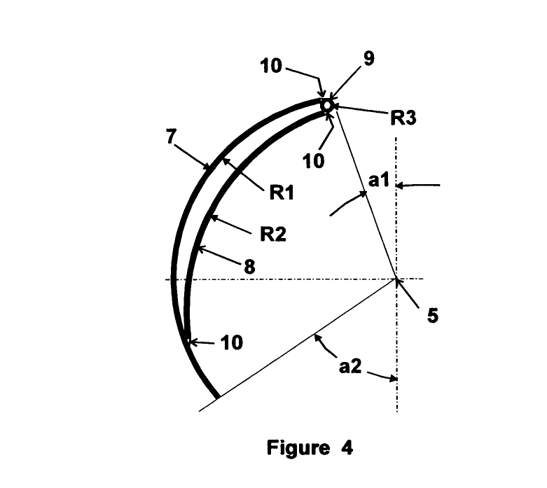

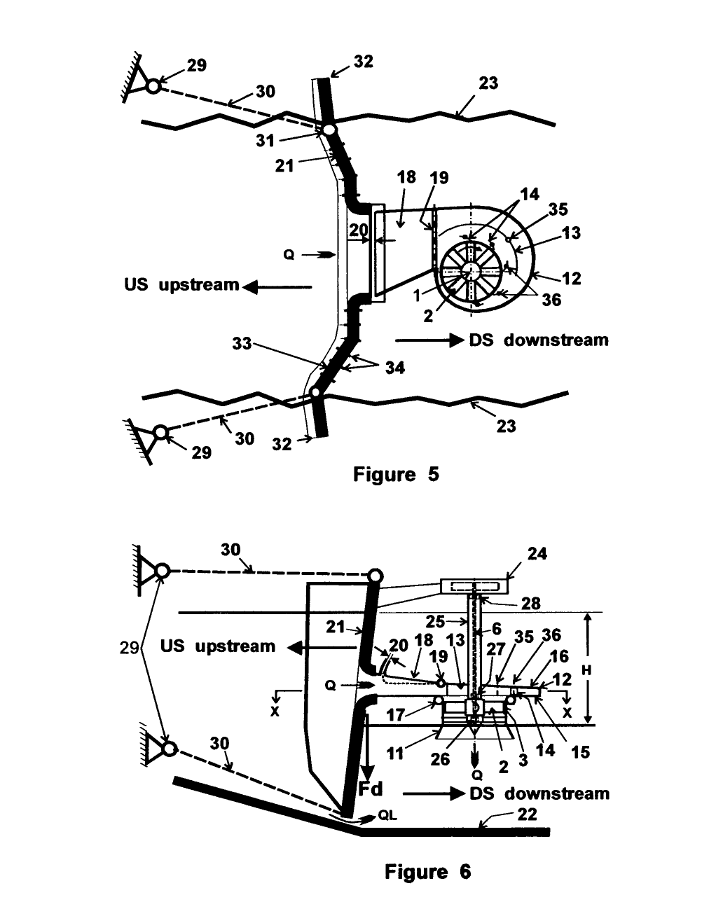

A possible application of the axial flow action turbine in accordance with this invention is presented in FIG. 5 and FIG. 6 showing the application in horizontal projection and vertical cross-section respectively. The turbine runner consisting of hub 1 buckets 2 and external ring 3 is positioned in the center of a drafts tube 11 which is arranged below a spiral casing 12. The spiral casing's 12 objective is to create a water flow with high tangential flow component Cu11 before meeting the turbine runner's buckets 2 as explained in connection with FIG. 2. Inside the spiral casing 12 separation walls 13 and guide vanes 14 ensure the even flow distribution and the mechanical stiffening of the bottom 15 and top cover 16 of the spiral casing 12. In the transition between the drafts tube 11 and bottom cover 15 a circular tube 17 ensures a smooth water flow. The number and arrangement of the separation walls 13 and guide vanes 14 are not limiting the validity of this invention. In accordance with this invention the separation wall 13 or parts of it as well as the guide vane 14 or parts of it can be turned around an axis 35 and 36 parallel to the turbine's rotational axis 6 in order to adjust the direction of the water flow depending on variation of the head H, water flow and other operational condition. The adjustment method through mechanical, hydraulic or pneumatic means does not limit the validity of this invention. Similarly the number of separation walls 13 and guide vanes 14 does not represent a limitation of this invention.

A possible water flow regulation can be achieved by a adjustable wall segment 18 in extension of the upper cover 16. The adjustable wall segment 18 is hinged 19 to the upper cover 16 and separated from the dam 21 by a narrow gap 20. The main objective of this arrangement is to limit the leakage flow through the gap 20 while ensuring a smooth regulation of the turbine's water flow Q. The choice and arrangement of the mechanical and/or hydraulic mechanism adjusting the adjustable wall segment 18 does not limit the validity of this invention.

The power produced by the axial flow action turbine can be transferred by a shaft 6 to a generator 24, or other converter arranged on a higher elevation. The shaft 6 can have guide bearings 26 and 27 below and above the turbine runner. These bearings can be water lubricated for the sake of simple maintenance. A guide bearing 28 at higher elevation for example below the generator 24 can be combined with an axial thrust bearing with oil or grease lubrication to carry the vertical hydraulic thrust and the weight load from the rotating components. There is a tubular structure 26 interconnecting the axial flow action turbine with the generator 24. The objective of this tubular structure 26 to transfer the mechanical forces and act as part of the spiral casing 12.

This invention does not exclude the option that the generator 24 will be immediately over or integrated into the axial flow action turbine. In this case the generator can be designed as a submersible electrical machine for operation partially or completely under water.

There are several known dam arrangements which may be used for the axial flow action turbine in accordance with this invention. However, the main idea behind the axial flow action turbine is to create a simple and low cost device. Therefore, in accordance with this invention the dam shall be a simple and easily deployable obstruction which creates the head H forcing the water through the turbine. FIG. 5. and FIG. 6 show a dam 21 design example in an assumed river bed defined by the bottom 22 and shore lines 23. Some water leakage QL at the bottom 22 and/or at the sides 23 of the dam 21 can be accepted. However, the dam 21 can be as a self-adjusting barrier suspended in a number of solidly fixed points 29 and connected to the dam 21 through tension members 30. The dam will act as a sail and with a down-stream tilt T of the dam 21 it will create a downward force Fd closing the bottom gap for the leakage flow QL. By moving the attachment points 31 at the dam 21 away from the side ends 32 of the dam 21 a similar self-adjusting gap closing can be achieved at the sides of the dam 21.

In accordance with this invention the dam 21 can built of vertical elements 33 which can be moved vertically adjustable in relation to each other in order to adapt the dam to the geometry of the bottom 22.

In accordance with the invention the vertical elements 33 are joined to each the adjacent element on the side through vertical joints 34 permitting an angular movement in the horizontal plan.

The validity of this invention is not limited by the number, distance and/or angular orientation of the axial flow action turbines in relation to the dam 21.

What is claimed is:

1. Axial flow action turbine utilizing the energy of moving water entering axially and tangentially into a turbine runner with cylindrical hub equipped with radial oriented buckets having cross-section consisting of segments of cylindrical tube where the segments are angularly offset along the bucket's radial axis and where the water exits the turbine runner axially.

2. Axial flow action turbine in accordance with claim 1 characterized by external ring interconnecting the external ends of the buckets.

3. Axial flow action turbine in accordance with any of the foregoing Claims characterized by bucket cross-section composed by more than one cylindrical tube segments.

4. Axial flow action turbine in accordance with any of the foregoing Claims characterized by the bucket's radial axis tilting in relation to the theoretical radial axis of the bucket.

5. Axial flow action turbine in accordance with any of the foregoing Claims characterized by having a spiral casing water inlet forcing the water to a circular motion before entering the runner with the buckets.

6. Axial flow action turbine in accordance with claim 5 characterized by spiral casing water inlet with gradually decreasing cross-section in the direction of the circular water flow and with annular opening in the bottom cover above the turbine runner's buckets.

7. Axial flow action turbine in accordance with any of the foregoing Claims characterized by vertical separation walls and guide vanes between the top and bottom covers.

8. Axial flow action turbine in accordance with claim 7 characterized by vertical separation walls and guide vanes turnable around axis parallel to the rotational axis of the turbine runner.

9. Axial flow action turbine in accordance with any of the foregoing Claims characterized by dam tilting in downstream direction.

10. Axial flow action turbine in accordance with claim 8 characterized by dam consisting of vertical segments movable in vertical and horizontal angular direction in relation to the adjacent segment.
